(19) United States
(12) Patent Application Publication
(10) Pub. No.: US 2013/0162746 A1
(43) Pub. Date: Jun. 27, 2013

(54) OPTICAL SCANNING APPARATUS AND IMAGE FORMING APPARATUS

(71) Applicant: CANON KABUSHIKI KAISHA, Tokyo (JP)

(72) Inventor: Daisuke Akagi, Abiko-shi (JP)

(73) Assignee: CANON KABUSHIKI KAISHA, Tokyo (JP)

(21) Appl. No.: 13/715,427

(22) Filed: Dec. 14, 2012

(30) Foreign Application Priority Data
Dec. 21, 2011 (JP) 2011-280242
Dec. 10, 2012 (JP) 2012-269188

(51) Int. Cl. B41J 2/385

(52) U.S. Cl. CPC G03G 15/0266
USPC 347/118

(57) ABSTRACT

When executing APC (Automatic Power Control), an optical scanning apparatus according to one aspect of this invention charges a hold capacitor for holding a voltage to be used to cause a light source (LD) to output a light beam to a preset predetermined voltage. After the hold capacitor has been charged to the predetermined voltage, the optical scanning apparatus supplies a driving current according to the voltage of the hold capacitor to the LD and causes the LD to output a light beam. In addition, the optical scanning apparatus charges or discharges the hold capacitor using the voltage generated in it as an initial value, thereby controlling the voltage of the hold capacitor such that the light power of the light beam detected by a PD approaches a target light power.

### BACKGROUND OF THE INVENTION

1. Field of the Invention

The present invention relates to an optical scanning apparatus and an image forming apparatus that uses the optical scanning apparatus.

2. Description of the Related Art

An electrophotographic image forming apparatus develops an electrostatic latent image formed on a photosensitive member by a toner and transfers and fixes the developed toner image to a recording material, thereby forming an image on the recording material. To form the electrostatic latent image on the photosensitive member, the image forming apparatus uses an optical scanning apparatus. The optical scanning apparatus includes a laser light source that emits a laser beam, and a deflector such as a rotating polygon mirror that deflects the laser beam emitted by the laser light source so that the laser beam scans the surface of the photosensitive member in a predetermined direction. To control the light power of the laser beam scanning the surface of the photosensitive member to a target light power, the image forming apparatus executes APC (Automatic Power Control).

In the APC, the light power of the laser beam emitted by the laser light source is detected using an optical sensor such as a photodiode. A driving current to be supplied to the laser light source is gradually adjusted such that the detected light power of the laser beam reaches the target light power.

The APC includes initial APC executed as an initial operation for making preparations for image formation and normal APC executed during image formation. The normal APC is to control the light power of the laser beam during, for example, the period of scanning the surface of the photosensitive member. On the other hand, the initial APC is to perform control to decide the value of the driving current to be supplied to the laser light source in a non-turn-on state as an initial operation when image data is input to the image forming apparatus.

Japanese Patent Laid-Open No. 7-171995 describes the initial APC. The light emission amount of a laser light source relative to a supplied driving current changes depending on the temperature of the light-emitting element or the time-rate change of the laser light source. To prevent the laser light source from being damaged by an excessive driving current supplied to it at the time of initial APC, Japanese Patent Laid-Open No. 7-171995 discloses initial APC that increases the driving current to be supplied to the laser light source stepwise from 0, thereby controlling the laser beam to the target light power.

However, since the initial APC described in Japanese Patent Laid-Open No. 7-171995 executes the step of increasing the driving current stepwise, a problem is posed that a control time that is relatively long is necessary after the start of the initial APC until the light power of the laser light source stabilizes near the target light power, and image formation can be started.

In particular, in a multi-beam system using a plurality of laser light sources, the initial APC is performed first for a specific laser light source to be used to generate a synchronization signal (to be referred to as a BD signal hereinafter) to define the image write position. After the light power has approached the target light power, the APC is started for the remaining laser light sources. For the remaining laser light sources, the APC needs to be performed at a timing so as not to cause the laser beam deflected by a polygon mirror to expose the photosensitive member. To detect such a timing, the light power of the laser beam to be used to generate the BD signal needs to be adjusted to a light power that allows BD signal generation. That is, after the initial APC has been performed for the specific laser light source, the initial APC is performed for the remaining laser light sources. For this reason, the time after the light power has been made to approach the target light power by the initial APC until image formation can be started for all laser light sources including the specific laser light source and the remaining laser light sources further prolongs as compared to the case in which a single laser light source is used. Hence, there is deemed necessary a technique of shortening the time after the start of initial APC until the light power of the laser light source approaches the target light power.

### SUMMARY OF THE INVENTION

The present invention has been made in consideration of the above-described problem, and provides a technique of enabling the light power of a laser light source to approach a target light power in a short time after turning on the laser light source when executing APC in an optical scanning apparatus.

According to one aspect of the present invention, there is provided an optical scanning apparatus for scanning a photosensitive member by a light beam, comprising: a light source configured to output the light beam having a light power according to a supplied driving current; a detection unit configured to detect the light power of the light beam output from the light source; a voltage holding unit configured to hold a voltage to be used to cause the light source to output the light beam; a charging unit configured to charge the voltage holding unit to a predetermined voltage; a control unit configured to control the charging unit so that the voltage holding unit is charged by the charging unit and configured to control the value of the driving current, wherein the control unit controls the charging unit so that the voltage holding unit holds a predetermined voltage in a state where the driving current is not supplied to the light source, controls the charging unit based on a detection result of the detection unit so that the voltage held in the voltage holding unit is controlled from the predetermined voltage of the voltage holding unit charged in the state where the driving current is not supplied to the light source, and controls the value of the driving current based on the voltage held in the voltage holding unit controlled by the control unit; and a current supply unit configured to supply, to the light source, the driving current according to the voltage controlled by the control unit.

According to another aspect of the present invention, there is provided an optical scanning apparatus for scanning a photosensitive member by a light beam, comprising: a light source configured to output the light beam having a light power according to a supplied driving current; a detection unit configured to detect the light power of the light beam output from the light source; a current holding unit configured to hold a current value of the driving current to be used to cause the light source to output the light beam; an adjustment unit configured to adjust the current value held by the current holding unit to a predetermined current value; a control unit configured to control the current value held by the current holding unit from the predetermined current value based on a detection result of the detection unit; and a current supply unit configured to supply, to the light source, the driving current corresponding to the current value held by the current holding unit, which is controlled by the control unit.

According to still another aspect of the present invention, there is provided an image forming apparatus comprising: a photosensitive member; a charger configured to charge the photosensitive member; an optical scanning apparatus configured to scan the surface of the photosensitive member by a light beam output from a light source when a driving current modulated based on image information is supplied from a current supply unit to the light source; and a developing unit configured to develop an electrostatic latent image formed on the surface of the photosensitive member by scanning of the light beam by the optical scanning apparatus to form, on the surface of the photosensitive member, an image to be transferred to a recording material, wherein the optical scanning apparatus comprises: the light source configured to output the light beam having a light power according to a supplied driving current; a detection unit configured to detect the light power of the light beam output from the light source; a voltage holding unit configured to hold a voltage to be used to cause the light source to output the light beam; a charging unit configured to charge the voltage holding unit to a predetermined voltage; a control unit configured to control the charging unit so that the voltage holding unit is charged by the charging unit and configured to control the value of the driving current, wherein the control unit controls the charging unit so that the voltage holding unit holds a predetermined voltage in a state where the driving current is not supplied to the light source, controls the charging unit based on a detection result of the detection unit so that the voltage held in the voltage holding unit is controlled from the predetermined voltage of the voltage holding unit charged in the state where the driving current is not supplied to the light source, and controls the value of the driving current based on the voltage held in the voltage holding unit controlled by the control unit; and the current supply unit configured to supply, to the light source, the driving current according to the voltage held by the voltage holding unit.

According to yet another aspect of the present invention, there is provided an image forming apparatus comprising: a photosensitive member; a charger configured to charge the photosensitive member; an optical scanning apparatus configured to scan the surface of the photosensitive member by a light beam output from a light source when a driving current modulated based on image information is supplied from a current supply unit to the light source; and a developing unit configured to develop an electrostatic latent image formed on the surface of the photosensitive member by scanning of the light beam by the optical scanning apparatus to form, on the surface of the photosensitive member, an image to be transferred to a recording material, wherein the optical scanning apparatus comprises: the light source configured to output the light beam having a light power according to a supplied driving current; a detection unit configured to detect the light power of the light beam output from the light source; a current holding unit configured to hold a current value of the driving current to be used to cause the light source to output the light beam; an adjustment unit configured to adjust the current value held by the current holding unit to a predetermined current value; a control unit configured to control the current value held by the current holding unit from the predetermined current value based on a detection result of the detection unit; and the current supply unit configured to supply, to the light source, the driving current corresponding to the current value held by the current holding unit, which is controlled by the control unit.

According to the present invention, it is possible to provide a technique of enabling the light power of a light source to approach a target light power in a short time after turning on the light source when executing APC in an optical scanning apparatus.

Further features of the present invention will become apparent from the following description of exemplary embodiments (with reference to the attached drawings).

### BRIEF DESCRIPTION OF THE DRAWINGS

FIG. 1 is a schematic sectional view of an image forming apparatus 100 according to the first embodiment;

FIG. 2 is a view showing the arrangement of an exposure controller 10 according to the first embodiment and the connection relationship between the exposure controller 10 and a sequence controller 47;

FIG. 3 is a block diagram showing the arrangement of a laser driving device 31 according to the first embodiment;

FIG. 4 is a block diagram showing the arrangement of an APC circuit 403 according to the first embodiment;

FIG. 5 is a flowchart showing the processing procedure of APC executed in the image forming apparatus 100 according to the first embodiment;

FIG. 6 is a timing chart showing the light emission sequence of the laser driving device 31 according to the first embodiment;

FIG. 7 is a block diagram showing the arrangement of the APC circuit 403 according to a modification of the first embodiment;

FIG. 8 is a graph showing an example of the light emission characteristic of an LD;

FIG. 9 is a block diagram showing the arrangement of an APC circuit 403 according to the second embodiment;

FIG. 10 is a flowchart showing the processing procedure of APC executed in an image forming apparatus 100 according to the second embodiment;

FIG. 11 is a block diagram showing the arrangement of the APC circuit 403 according to the second embodiment; and

FIG. 12 is a timing chart showing a comparative example of the light emission sequence of the laser driving device 31.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

### <Arrangement of Image Forming Apparatus 100>

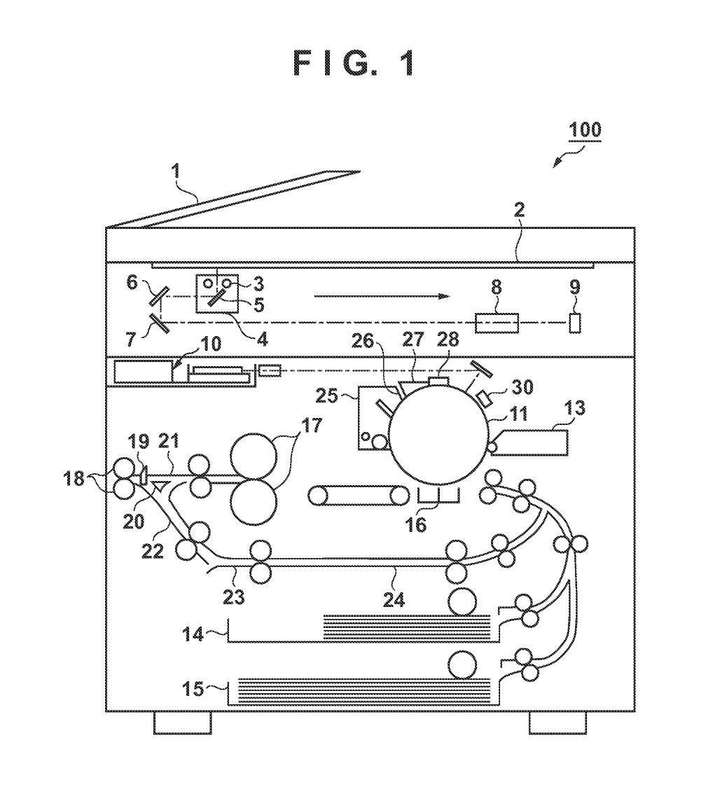

The basic operation of an optical scanning apparatus and an image forming apparatus according to the first embodiment of the present invention will be described first with reference to FIG. 1. FIG. 1 is a schematic sectional view of an image forming apparatus 100 according to this embodiment.

In the image forming apparatus 100, documents stacked on a document feeder 1 are sequentially conveyed onto the surface of a platen glass 2 one by one. When the document is conveyed onto the surface of the platen glass 2, a lamp unit 3 of a reading unit 4 is turned on, and the reading unit 4 irradiates the document with light while moving in the direction of an arrow 110. The light reflected by the document passes through a lens 8 via mirrors 5, 6, and 7 and is then input to an image sensor unit 9 and converted into an image signal. The image signal output from the image sensor unit 9 is temporarily stored in an image memory (not shown). After that, the image signal is read out from the image memory and input to an exposure controller 10.

The exposure controller 10 irradiates the surface of a photosensitive member 11 with a laser beam in accordance with an input image signal and scans the surface of the photosensitive member 11 by the laser beam, thereby exposing the photosensitive member 11. An electrostatic latent image is thus formed on the surface of the photosensitive member 11. A potential sensor 30 detects the surface potential of the photosensitive member 11 and simultaneously monitors whether the surface potential has a desired value. When a developer 13 develops the electrostatic latent image formed on the surface of the photosensitive member 11, an image (toner image) to be transferred to a recording material is formed on the surface of the photosensitive member 11. The toner image on the surface of the photosensitive member 11 moves to a transfer unit 16 as the photosensitive member 11 rotates, and is transferred to the surface of a recording material there.

The recording material to which the toner image is to be transferred by the transfer unit 16 is fed and conveyed from a recording material stacking unit 14 or 15 in synchronization with a timing at which the toner image reaches the transfer unit 16. The recording material to which the toner image has been transferred by the transfer unit 16 is conveyed to a fixing unit 17. The fixing unit 17 fixes the toner image on the surface of the recording material. After the fixing processing by the fixing unit 17, the recording material is discharged from a discharge unit 18 to the outside of the image forming apparatus 100.

After the transfer by the transfer unit 16 has been done, a cleaner 25 collects the toner remaining on the surface of the photosensitive member 11, thereby cleaning the surface of the photosensitive member 11. Next, an auxiliary charger 26 removes charges from the surface of the photosensitive member 11 so that the photosensitive member 11 can obtain a satisfactory charge characteristic upon charging by a primary charger 28 at the next time of image formation. In addition, after the residual charges on the surface of the photosensitive member 11 are removed by a pre-exposure lamp 27, the primary charger 28 charges the surface of the photosensitive member 11. The image forming apparatus 100 executes image formation for a plurality of recording materials by repeating the above-described processing.

<Arrangement of Exposure Controller 10>

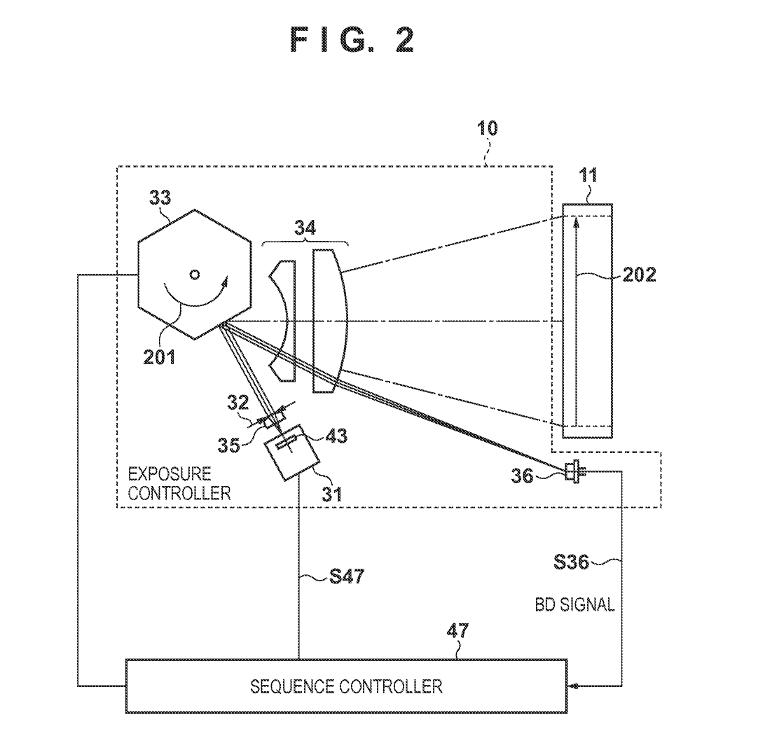

FIG. 2 is a view showing the schematic arrangement of the exposure controller 10 according to this embodiment and connection between the exposure controller 10 and a sequence controller 47. The sequence controller 47 includes a CPU (not shown), and the CPU controls the exposure controller 10 and the photosensitive member 11. As shown in FIG. 2, the exposure controller 10 includes a laser driving device 31, a collimator lens 35, a stop 32, a polygon mirror 33, an f-θ lens 34, and a BD (Beam Detect) sensor 36. The laser driving device 31 includes a laser chip 43. The laser chip 43 includes a plurality of semiconductor lasers (laser diodes (LDs)) as laser light sources, and also includes one photodiode (PD). That is, the exposure controller 10 is formed from the multi-beam laser chip 43 including a plurality of LDs. Note that in this embodiment, the exposure controller 10 and the sequence controller 47 form an example of an optical scanning apparatus that scans a scanning target (photosensitive member 11) by a light beam.

The operation of the exposure controller 10 based on the control of the sequence controller 47 will be described next. In the image forming apparatus 100, the sequence controller 47 controls the laser driving device 31 using a control signal S47 output to the laser driving device 31. When image formation starts, the sequence controller 47 controls the laser driving device 31 by the control signal S47 so that each of the plurality of LDs in the laser chip 43 emits light of a desired light power in accordance with the light emission sequence to be described later and outputs a light beam (laser beam). Each laser beam emitted by the laser chip 43 is converted into a substantially collimated light beam via the collimator lens 35 and the stop 32, and then enters the polygon mirror 33 in a predetermined spot diameter.

The polygon mirror 33 has a plurality of mirror surfaces and rotates in the direction of an arrow 201 at a uniform angular velocity. Along with the rotation in the direction of the arrow 201, the polygon mirror 33 reflects each laser beam so that the laser beams that have entered are deflected at continuous angles. Each laser beam deflected by the polygon mirror 33 enters the f-θ lens 34. The f-θ lens 34 applies a condenser effect to the plurality of laser beams that have entered, and corrects distortion to guarantee temporal linearity when the plurality of laser beams scan the surface of the photosensitive member 11. The plurality of laser beams thus combine on the surface of the photosensitive member 11 and scan the surface in the direction of an arrow 202 at a uniform velocity.

The BD sensor 36 is a sensor used to detect light reflected by the polygon mirror 33. The BD sensor 36 is arranged at a position to detect a laser beam on the scan start side out of the laser beams reflected by the mirror surfaces of the polygon mirror 33. Upon detecting the laser beam, the BD sensor 36 outputs a signal (BD signal) S36 indicating the detection of the laser beam to the sequence controller 47. The sequence controller 47 uses the received BD signal S36 as a synchronization signal to synchronize the rotation of the polygon mirror 33 with the image write start timing using an image signal in the laser driving device 31.

The sequence controller 47 monitors the period of output of the BD signal S36 from the BD sensor 36, thereby monitoring the period of laser beam detection by the BD sensor 36. In addition, the sequence controller 47 performs control to accelerate or decelerate a polygon mirror driver (not shown) for driving the polygon mirror 33 based on the monitoring result such that the period of one rotation of the polygon mirror 33 is always constant. By this control, the sequence controller 47 sets the polygon mirror 33 in a stable rotation state.

<Arrangement of Laser Driving Device 31>

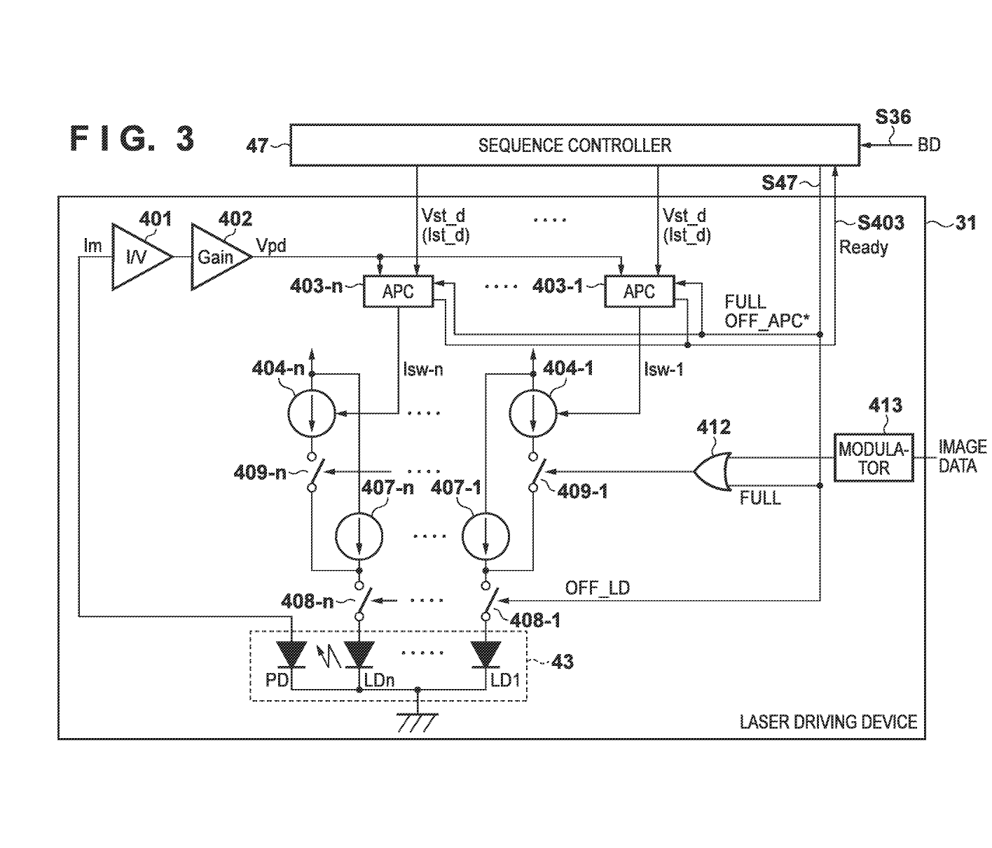

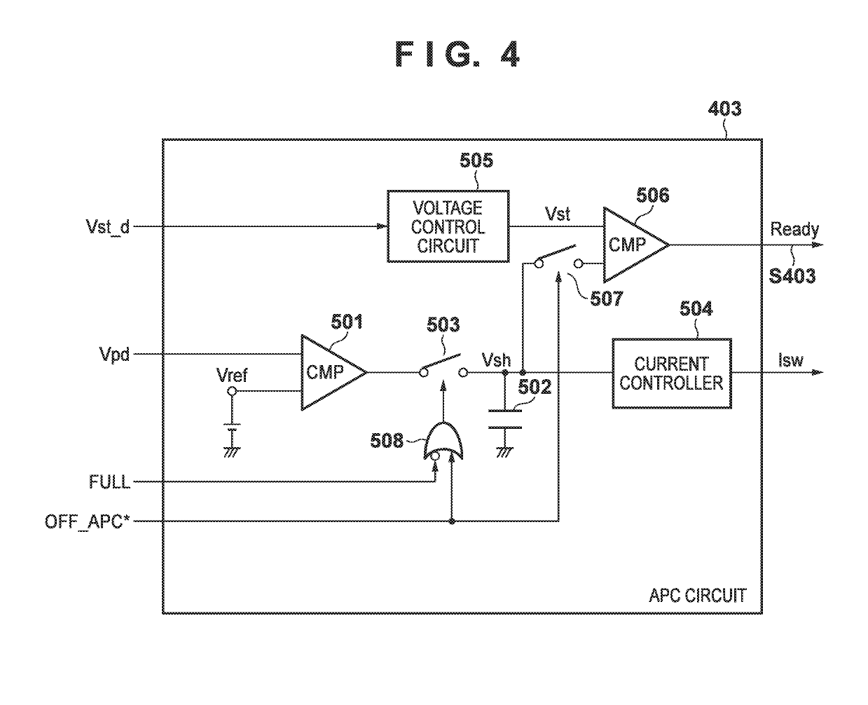

The arrangements of the laser driving device 31 and an APC circuit 403 (APC circuits 403-1 and 403-n) included in the laser driving device 31 will be described next with reference to FIGS. 3 and 4. In this embodiment, the laser driving device 31 is assumed to be of a multi-beam device using a plurality of laser light sources. The arrangement of the laser driving device 31 will be described first with reference to FIG. 3.

The laser driving device 31 includes the multi-beam laser chip 43. The laser chip 43 includes a plurality of (n) LDs (LD1 to LDn) and one photodiode (PD). The laser driving device 31 is also provided with the plurality of APC circuits 403-1 to 403-n in correspondence with the plurality of LDs (LD1 to LDn).

The PD in the laser chip 43 detects a laser beam from each of the LD1 to LDn, and outputs a current Im corresponding to the detected light power to a current/voltage converter 401. The current/voltage converter 401 converts the received current Im into a voltage and outputs it. An amplifier 402 is used to adjust the gain of the voltage output from the current/voltage converter 401. That is, the amplifier 402 adjusts the gain of the output from the PD that has detected the laser beam from each of the LD1 to LDn. The voltage that has undergone the gain adjustment by the amplifier 402 is supplied from the amplifier 402 to the APC circuit 403 as a light power monitor voltage Vpd. Note that the PD in the laser chip 43, the current/voltage converter 401, and the amplifier 402 function as a detection unit that detects the light power of a light beam output from each laser light source.

The laser driving device 31 is controlled by the sequence controller 47 based on various kinds of control signals included in the control signal S47 output from the sequence controller 47, as described above. The control signal S47 includes, for example, full turn-on signals (APC mode signals) FULL-1 to FULL-n to be supplied to a logical element 412 and the APC circuits 403-1 and 403-n, OFF mode signals OFF_LD to be supplied to switches 408-1 to 408-n, and control signals OFF_APC* (charge mode signals) to be supplied to the APC circuits 403-1 to 403-n.

The control signal S47 (OFF_APC* and FULL) from the sequence controller 47 is input to each of the APC circuits 403-1 to 403-n. In addition to the control signal S47, preset setting data Vst_d representing a target voltage Vst (predetermined voltage) necessary for an initial charging operation (to be described later) executed before the start of APC is input from the sequence controller 47 to each of the APC circuits 403-1 to 403-n. Note that the APC circuits 403-1 to 403-n internally hold a reference voltage Vref necessary for APC, as will be described later. Under the control of the sequence controller 47, each of the APC circuits 403-1 to 403-n performs control to adjust the light power of a corresponding one of LDs (LD1 to LDn) to cause the plurality of LDs (LD1 to LDn) to emit light of a predetermined light power. Each of the APC circuits 403-1 to 403-n executes light power control of a corresponding LD based on the reference voltage Vref in accordance with the control signal S47 from the sequence controller 47.

A modulator 413 outputs, to the logical element 412, an image modulation signal to be used to modulate driving currents to be supplied to the LD1 to LDn using an image data (image information) input from an image data generation unit (not shown) or the like. For example, to perform PWM (pulse width modulation) of a driving current, the modulator 413 outputs a pulse signal having a width corresponding to image data to the logical element 412 as an image modulation signal. The logical element 412 outputs, to switches 409-1 to 409-n, the OR (logical addition) of the image modulation signal output from the modulator 413 and the full turn-on signal FULL output from the sequence controller 47.

As shown in FIG. 3, the laser driving device 31 includes current sources 404-1 to 404-n and 407-1 to 407-n for supplying (applying) driving currents to the LD1 to LDn in the laser chip 43. The laser driving device 31 also includes the switches 408-1 to 408-n and 409-1 to 409-n that switch the current supply states from the current sources to the LD1 to LDn. For example, the driving current for the LD1 is supplied from the current sources 404-1 and 407-1, and the supply state is switched by the switches 408-1 and 409-1. The operations of the current sources 404-1 and 407-1 and the switches 408-1 and 409-1 corresponding to the LD1 out of the LD1 to LDn will mainly be described below. The description of LD1 also applies to the remaining lasers LD2 to LDn.

The switching current source 404-1 and the bias current source 407-1 for supplying a driving current to the LD1 are connected in parallel between the power supply and the LD1. The APC circuit 403-1 performs variable control of the current supplied from the switching current source 404-1 to the LD1 using a current control signal output to the switching current source 404-1. The APC circuit 403-1 outputs a switching current value Isw-1 to the switching current source 404-1 by the current control signal, thereby designating a value of a switching current to be supplied from the switching current source 404-1 to the LD1. The switching current source 404-1 supplies a switching current corresponding to the switching current value Isw-1 given by the APC circuit 403-1 to the LD1 as a driving current. The switch 409-1 is connected between the LD1 and the switching current source 404-1. For this reason, driving current supply from the switching current source 404-1 to the LD1 is set to the on/off state in accordance with the on/off state of the switch 409-1. On the other hand, the bias current source 407-1 supplies a predetermined bias current to the LD1.

The switch 408-1 is connected to the path from the switching current source 404-1 and the bias current source 407-1 to the LD1. The sequence controller 47 controls the switch 408-1 between the on and off states using the signal OFF_LD output to the switch 408-1. In this embodiment, if the signal OFF_LD output from the sequence controller 47 is in the high state (“H”), the switch 408-1 is turned off, and in the low state (“L”), the switch 408-1 is turned on. If the switch 408-1 is on, the switching current source 404-1 and the bias current source 407-1 supply the currents to the LD1. On the other hand, if the switch 408-1 is off, current supply from the switching current source 404-1 and the bias current source 407-1 to the LD1 is forcibly cut off.

When the switch 408-1 is on, and the switch 409-1 is off, the switching current is not supplied from the switching current source 404-1 to the LD1, and the bias current is supplied from the bias current source 407-1 to the LD1. The bias current is supplied to increase the light emission responsibility of the LD1. Even when the bias current is supplied to the LD1, the light power of the light beam emitted by the LD1 is small, and the potential of the surface of the photosensitive member 11 does not change. Note that the switch 409-1 is controlled to the on or off state based on a signal supplied from the modulator 413 via the logical element 412.

When the switch 408-1 is on, and the switch 409-1 is on, the bias current from the bias current source 407-1 and the switching current from the switching current source 404-1 are supplied to the LD1 as the driving current. In this case, the LD1 outputs, to the surface of the photosensitive member 11, a light beam (laser beam) of a light power necessary for forming an electrostatic latent image on the surface.

Note that each of the APC circuits 403-1 to 403-n can output a signal indicating the internal state of the APC circuit, for example, a Ready signal to be described later to the sequence controller 47 as a status signal S403.

<Operation Mode of Laser Driving Device 31>

The operation mode of the laser driving device 31 shown in FIG. 3 will be described next. The laser driving device 31 operates in various operation modes selectively based on the control signal S47 input from the sequence controller 47. Each operation mode of the laser driving device 31 will be described below. Note that in this embodiment, an operation mode including APC to be performed before the image forming apparatus 100 starts image formation will be referred to as an “initial APC mode”, and an operation mode including APC to be performed after the start of image formation will be referred to as a “normal APC mode”.

(1) OFF Mode

When the signal OFF_LD (OFF mode signal) input from the sequence controller 47 is “H”, the laser driving device 31 operates in the OFF mode. When the signal OFF_LD is “H”, the switch 408-1 is turned off, supply of driving currents (bias current and switching current) to the LD1 is cut off, and the LD1 is set in the turn-off state, as described above.

(2) Normal APC Mode

The normal APC mode is an operation mode in which each LD is fully turned on for a predetermined time, and the light power is monitored, thereby performing APC, at a timing synchronized with the BD signal after completion of APC in the initial APC mode to be described later. During the time when the full turn-on signals FULL-1 to FULL-n (APC mode signals) out of the control signal S47 input from the sequence controller 47 is “H”, the laser driving device 31 executes the APC for the corresponding LDs. When the APC mode signals FULL-1 to FULL-n are switched from “L” to “H” every time the BD signal is detected after completion of the initial APC mode, the laser driving device 31 executes APC in the normal APC mode for the corresponding LDs.

In the normal APC mode, the switches 408-1 to 408-n controlled by the signal OFF_LD are turned on. In addition, when the APC mode signals FULL-1 to FULL-n change from “L” to “H”, the modulation switches 409-1 to 409-n switch from the off state to the on state. This enables the bias current sources 407-1 to 407-n and the switching current sources 404-1 to 404-n to supply the currents to the corresponding LD1 to LDn. When the APC mode signals FULL-1 to FULL-n=“H”, the APC circuits 403-1 to 403-n execute APC for the corresponding LD1 to LDn. The APC circuits 403-1 to 403-n control the driving currents (switching currents Isw-1 to Isw-n) to be supplied from the switching current sources 404-1 to 404-n to the LD1 to LDn based on the light power monitor voltage Vpd corresponding to the current Im from the PD in the laser chip 43. The APC circuits 403-1 to 403-n control the driving currents to be supplied to the LD1 to LDn, thereby controlling the light powers of the laser beams output from the LD1 to LDn to predetermined target light powers.

(3) Initial APC Mode

The initial APC mode is an operation mode in which the light power of each of the LD1 to LDn is controlled to a target value (target light power) from a state in which the LD1 to LDn are completely off. The image forming apparatus 100 executes APC in the initial APC mode before the start of image formation. The initial APC mode of this embodiment includes an initial charging operation of charging a hold capacitor included in each of the APC circuits 403-1 to 403-n to the predetermined target voltage Vst in a state in which the LD1 to LDn are turned off before the start of APC, as will be described later. The target voltage Vst is predetermined as a voltage near the reference voltage Vref corresponding to the target light power. In the initial APC mode, the APC is executed for a predetermined time after completion of the initial charging operation. That is, the hold capacitor in each of the APC circuits 403-1 to 403-n is charged to some degree in advance at the start of APC so that the LD1 to LDn can be set not in a complete turn-off state but in a state in which the LD1 to LDn emit light of some light power. This feature enables the APC to make the light powers of the LD1 to LDn approach the target light powers in a short time.

When a control signal OFF_APC* (charge mode signal) out of the control signal S47 input from the sequence controller 47 changes from “L” to “H”, the laser driving device 31 executes the initial charging operation. During the initial charging operation, the signal OFF_LD is “H”. No driving current is supplied to the LD1 to LDn, and the LD1 to LDn maintain the turn-off state. The charge mode signal OFF_APC* from the sequence controller 47 is input to the APC circuits 403-1 to 403-n.

During the time in which the charge mode signal OFF_APC*=“L”, each of the APC circuits 403-1 to 403-n raises the voltage of the internal hold capacitor, thereby charging the hold capacitor, as will be described later. The APC circuits 403-1 to 403-n thus perform a preparation operation before the start of driving current supply from the current sources (the bias current sources 407-1 to 407-n and the switching current sources 404-1 to 404-n) to the LD1 to LDn start. After the charging of the internal hold capacitors is completed, and the charge mode signal OFF_APC* has switched to “H”, the APC circuits 403-1 to 403-n execute APC for a predetermined time, thereby controlling the light powers of the laser beams output from the LD1 to LDn to the target light powers.

(4) VIDEO Mode

Except the modes (1) to (3), the laser driving device 31 operates in the VIDEO mode. In the VIDEO mode, the laser driving device 31 perform switching-drive for the switching current sources 404-1 to 404-n based on image data input from an image data generation unit (not shown) or the like. The laser driving device 31 thus irradiates the surface of the photosensitive member 11 with a laser beam corresponding to the input image data.

<Comparative Example of APC in Laser Driving Device 31>

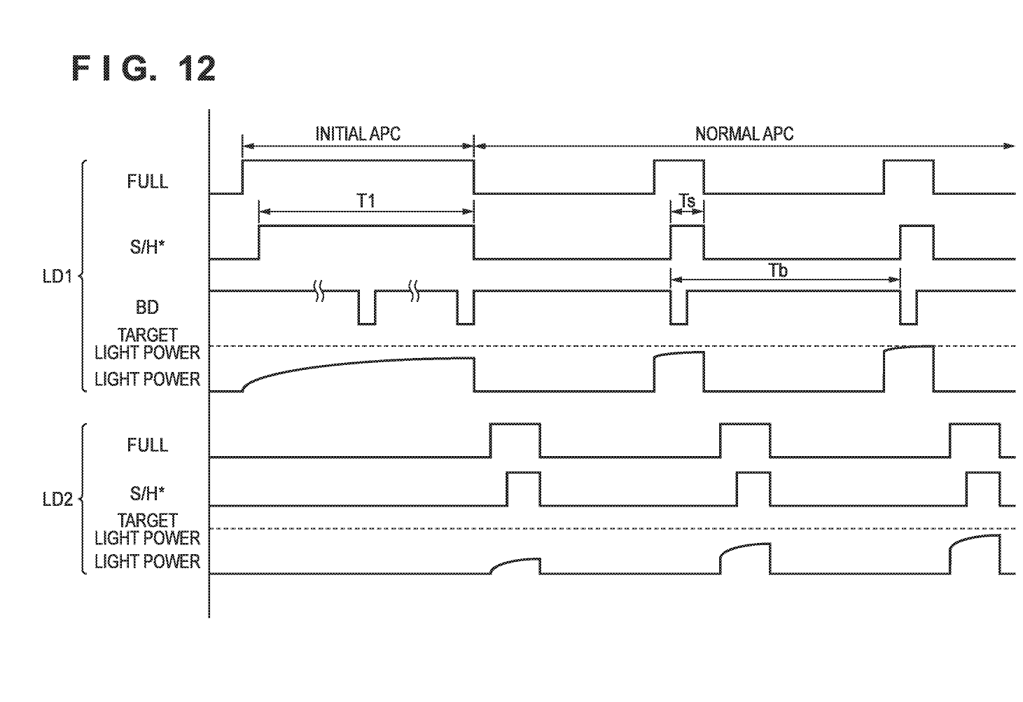

A comparative example of APC in the laser driving device 31 according to this embodiment will be described next with reference to FIG. 12. For the sake of descriptive simplicity, APC by the APC circuit 403 (APC circuit 403-1) for the LD1 will only be explained below. For the remaining lasers (LD2 to LDn) as well, the APC can be implemented by performing the same control as that of the LD1.

When executing APC for an LD included in the laser driving device 31, if the light power of the LD is controlled after turning on the LD in the turn-off state, a considerable time may be necessary until the light power sufficiently approaches the target light power. FIG. 12 shows an example of the light emission sequence of the laser driving device 31 as a comparative example to the embodiment to be described below. In FIG. 12, an operation mode including APC to be performed before the image forming apparatus 100 starts image formation will be referred to as an “initial APC mode”, and an operation mode including APC to be performed after the start of image formation will be referred to as a “normal APC mode”. FIG. 12 shows the light emission sequence for two LDs (LD1 and LD2) out of the LDs included in the laser driving device 31. The LD1 is an LD used to detect a BD signal and is assumed to be an LD for which the APC is executed first out of the plurality of LDs.

Referring to FIG. 12, first, to start the APC of the initial APC mode, the sequence controller 47 switches the full turn-on signal FULL of the LD1 from “L” to “H” to turn on the LD1. In addition, the sequence controller 47 switches the sample hold signal S/H* (S/H*−1) of the LD1 from “L” to “H” to shift to a state to sample the light power of the LD1 detected by the PD. In this state, the detected light power of the LD1 gradually increases. This is because the sequence controller 47 controls the driving current to be supplied to the LD1 such that the detected light power of the LD1 approaches the target light power.

More specifically, the light power monitor voltage Vpd corresponding to the light power of the LD1 detected by the PD in the laser chip 43 is input to the APC circuit 403. If the APC circuit 403 is in the sample state, the hold capacitor in the APC circuit 403 is charged to the light power monitor voltage Vpd. The APC circuit 403 compares the light power monitor voltage Vpd generated in the hold capacitor with the reference voltage Vref corresponding to the target light power. In addition, the APC circuit 403 decides the switching current value Isw (Isw-1) based on the comparison result such that the voltage of the hold capacitor approaches the reference voltage Vref. The switching current value Isw is output from the APC circuit 403 to the switching current source 404-1 as a current control signal. The switching current source 404-1 supplies a switching current corresponding to the switching current value Isw to the LD1. During the sample state, the APC circuit 403 continuously controls the switching current value Isw based on the light power monitor voltage Vpd and the reference voltage Vref. The sequence controller 47 thus controls the light power of the LD1 using the APC circuit 403. When the light power of the LD1 has sufficiently approached the target light power, and it has become possible to stably detect the BD signal, the sequence controller 47 ends the initial APC mode and shifts to the normal APC mode. When starting APC of the normal APC mode, the sequence controller 47 sets the LD1 in a full turn-on state for a predetermined period Ts and samples the light power every time a BD signal is detected (in every scanning of the light beam). The sequence controller 47 thus executes the APC by controlling the driving current to the LD1 such that the light power of the LD1 approaches the target light power, as in the above-described initial APC mode. The APC of the initial APC mode makes light power of the LD1 sufficiently approach the target light power. Hence, in the APC of the normal APC mode, the light power of the LD1 can be stabilized at the target light power by several times of APC executed every time a BD signal is detected.

In the APC of the initial APC mode described above, however, the driving current of, for example, the LD1 is gradually increased from 0, thereby gradually making the light power of the LD1 approach the target light power. For this reason, a relatively long time T1 long is necessary until the light power of the LD1 sufficiently approaches the target light power, and it becomes possible to stably detect the BD signal, as shown in FIG. 12.

In addition, a longer time is necessary for the LD2 after the driving current is supplied to turn on the LD2 until its light power sufficiently approaches the target light power. As shown in FIG. 12, after the shift from the initial APC mode to the normal APC mode, the sequence controller 47 switches the full turn-on signal FULL of the LD2 from “L” to “H” to turn on the LD2. In addition, the sequence controller 47 switches the sample hold signal S/H* from “L” to “H” to sample the light power of the LD2, and performs control to make the light power of the LD2 approach the target light power, thereby performing the APC of the LD2. After that, light power control of the LD2 is repetitively performed next to the light power control of the LD1 at a period Tb of BD signal detection.

In this manner, after the APC of the initial APC mode for the LD1 has ended, control is performed in the normal APC mode to make the light power of the LD2 gradually approach the target light power from the turn-off state, thereby performing the APC. For this reason, the time until the light power of the LD2 reaches the target light power is longer than that of the LD1. Hence, in the multi-beam system, the time until the light powers of all of the plurality of LDs are controlled to the target light power by the APC (initial APC mode and normal APC mode) becomes longer as a whole. For example, a time T2 necessary after the light power control of the LD2 has started until the light power reaches the target light power is approximately Tb×T1/Ts. For example, assume that T1=10 [ms], Ts=10 [μs], and Tb=500 [μs]. In this case, T2=500 [ms]. In the multi-beam system, when the number of LDs increases, the time until the light powers of all LDs reach the target light power prolongs in proportional to the number of LDs.

In this embodiment, when executing APC of the initial APC mode for the laser driving device 31, light power control can start from a light power close to the target light power in order to make the light power of the LD approach the target light power in a short time after turning on the LD. More specifically, the hold capacitor is charged such that its voltage equals the target voltage. After charged to the target voltage (this state is defined as the initial state, and the voltage at this time is defined as the initial voltage), the hold capacitor is charged or discharged based on the detection result of the PD. That is, the hold capacitor is charged in advance to the preset target voltage during the turn-off state of the LD (before turn-on) before optical scanning for scanning the surface of the photosensitive member 11 by the laser beam output from the LD starts and before the light beam is made to enter the PD. The voltage held by the hold capacitor is the voltage used to cause the LD to emit light, and is used to decide the driving current to be supplied to the LD. The target voltage is preset to a voltage corresponding to the target light power or a light power near the target light power.

Additionally, in this embodiment, when turning on the LD and performing the light power control (APC) of the LD, the voltage of the hold capacitor is controlled using the voltage obtained by the charging in the turn-off state as the initial value. That is, control of the voltage of the hold capacitor can be started from a voltage close to the reference voltage corresponding to the target light power. This allows the light power of the LD to reach the target light power in a short time by the APC of the initial APC mode and the normal APC mode, as compared to a case in which the above-described charging operation is not performed.

<Arrangement of APC Circuit 403 (403-1 to 403-n) According to This Embodiment>

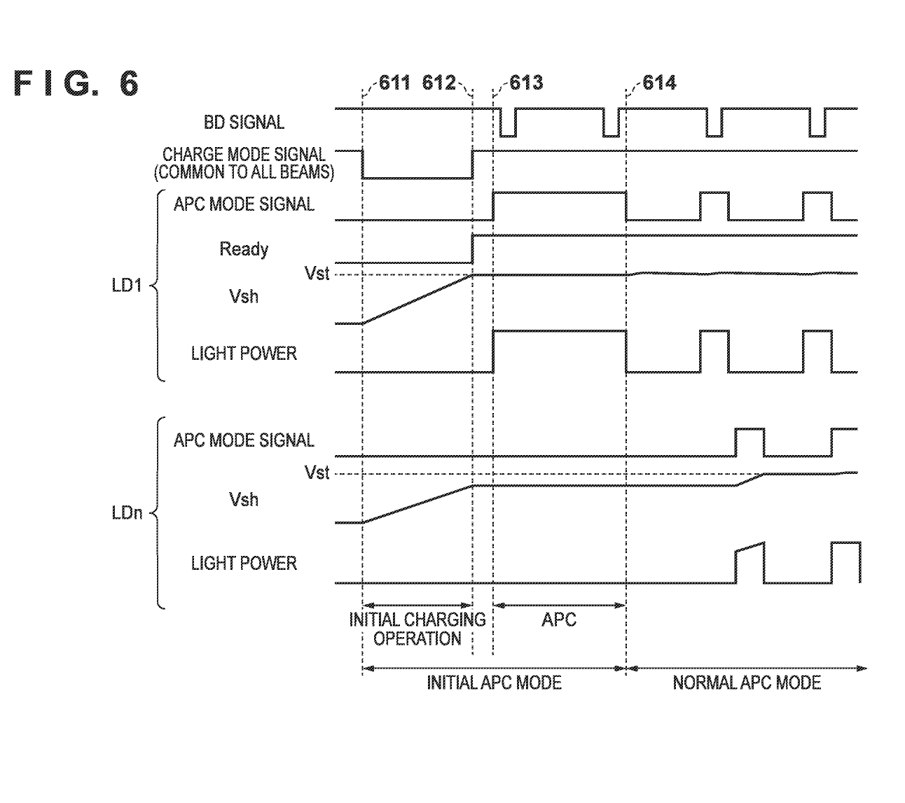

The arrangement of the APC circuits 403-1 and 403-n included in the laser driving device 31 according to this embodiment will be described next with reference to FIG. 4. Each of the APC circuits 403-1 and 403-n performs APC for a corresponding one of the LDs (LD1 to LDn). Note that the explanation to be made below also corresponds to a light emission sequence shown in FIG. 6. For the sake of descriptive simplicity, APC by the APC circuit 403-1 for the LD1 will only be explained below. For the remaining lasers (LD2 to LDn) as well, the APC can be implemented by performing the same control as that of the LD1. Since the APC circuits 403-1 to 403-n have the same arrangement, the APC circuits 403-1 to 403-n will be expressed as the APC circuit 403 below.

The APC circuit 403 includes comparators 501 and 506, a hold capacitor 502, a sample/hold (S/H) switch 503, a current controller 504, and a monitor switch 507. The APC circuit 403 receives the setting data Vst_d representing the target voltage Vst necessary for the initial charging operation and the light power monitor voltage Vpd output from the amplifier 402. The APC circuit 403 also receives the charge mode signal OFF_APC* and the full turn-on signal (APC mode signal) FULL out of the control signal S47 output from the sequence controller 47.

The comparator 501 compares the received light power monitor voltage Vpd with the reference voltage Vref. The voltage to be generated in the hold capacitor 502 is controlled based on the comparison result. The hold capacitor 502 generates a voltage Vsh corresponding to charges accumulated by the current flowing from the comparator 501. The S/H switch 503 is controlled between the on and the off states based on the signal output from a logical element 508. When the signal is “H”, the S/H switch 503 is turned off. When the signal is “L”, the S/H switch 503 is turned on. When the S/H switch 503 is on, the hold capacitor 502 is set in the sample state (a state in which charges are accumulated or removed). On the other hand, when the S/H switch 503 is off, the hold capacitor 502 is set in the hold state (a state in which the voltage Vsh generated in the capacitor at that point of time is held). The current controller 504 decides and outputs the switching current value Isw (Isw-1) in accordance with the voltage Vsh of the hold capacitor 502.

The charge mode signal OFF_APC* and the APC mode signal FULL are input to the logical element 508. However, the APC mode signal FULL is input to the logical element 508 after its logic is inverted (H→L or L→H). The logical element 508 outputs a signal representing the OR of the inputs to the S/H switch 503. Hence, when the charge mode signal OFF_APC*=“L” or the APC mode signal FULL=“H”, the logical element 508 outputs a signal representing “L”. As a result, the S/H switch 503 is turned on, and the hold capacitor 502 shifts to the sample state. On the other hand, when the charge mode signal OFF_APC*=“H” or the APC mode signal FULL=“L”, the logical element 508 outputs a signal representing “H”. As a result, the S/H switch 503 is turned off, and the hold capacitor 502 shifts to the hold state.

The current controller 504 outputs the switching current value Isw-1 corresponding to the voltage Vsh of the hold capacitor 502 as a current control signal. The current control signal (current value Isw-1) output from the APC circuit 403 is supplied to the switching current source 404-1. The switching current source 404-1 outputs a switching current corresponding to the current value Isw-1. The switching current is added to the bias current from the bias current source 407-1 and supplied to the LD1 as a driving current.

As described above, in this embodiment, the hold capacitor 502 functions as a voltage holding unit that holds a voltage used to cause a corresponding one of the light sources (LD1 to LDn) to output a light beam (laser beam). The current controller 504 and the switching current source 404-1 function as a current supply unit that supplies a driving current corresponding to the voltage of the voltage holding unit (hold capacitor 502) to the light source (LD) when optical scanning for the photosensitive member 11 starts.

A voltage control circuit 505 generates the target voltage Vst corresponding to the set value Vst_d input from the sequence controller 47 and applies it to the comparator 506. The comparator 506 compares the target voltage Vst applied from the voltage control circuit 505 with the voltage Vsh of the hold capacitor 502, thereby monitoring the voltage Vsh. The monitor switch 507 is controlled between the on and off states in accordance with the charge mode signal OFF_APC*. When the signal is “H”, the monitor switch 507 is turned off. When the signal is “L”, the monitor switch 507 is turned on. The monitor switch 507 is used to switch whether or not to monitor the voltage Vsh by the comparator 506. When the monitor switch 507 is on, the comparator 506 monitors the voltage Vsh. Based on the monitor result, the comparator 506 outputs the Ready signal to the sequence controller 47 as the status signal S403. The operation of the APC circuit 403 in the each of above-described operation modes will be described below.

(1) OFF Mode

To set the laser driving device 31 in the OFF mode, the sequence controller 47 sets the OFF mode signal OFF_LD=“H”, as described above. At this time, the sequence controller 47 sets the charge mode signal OFF_APC*=“H”, and the APC mode signal FULL=“L”. Hence, in the OFF mode, the S/H switch 503 maintains the off state. For this reason, the hold capacitor 502 is in the hold state and holds the voltage Vsh at that point of time.

(2) Normal APC Mode

To set the laser driving device 31 in the normal APC mode, the sequence controller 47 sets the APC mode signal FULL=“H” to turn on the S/H switch 503, as described above. The hold capacitor 502 shifts to the sample state in which charges are accumulated or removed in accordance with the output from the comparator 501. In the normal APC mode, each of the LD1 to LDn receives the driving current and emits light of a light power corresponding to the driving current. When the LD1 to LDn emit light, the light power monitor voltage Vpd corresponding to the light power detected by the PD is input to the APC circuit 403 and to the comparator 501. The APC circuit 403 holds the reference voltage Vref by an internal power supply. The reference voltage Vref is input to the comparator 501.

The comparator 501 compares the light power monitor voltage Vpd with the reference voltage Vref.

Upon determining, as a result of comparison, that

Vpd<Vref (1)

the comparator 501 supplies a current to the hold capacitor 502 connected to the next stage via the S/H switch 503, thereby raising the voltage Vsh generated in the capacitor. On the other hand, upon determining that

Vpd>Vref (2)

the comparator 501 draws a current from the hold capacitor 502, thereby lowering the voltage Vsh generated in the capacitor. Note that upon determining that

Vpd=Vref (3)

the comparator 501 does not perform current supply or drawing for the hold capacitor 502, and keeps the voltage Vsh of the capacitor constant.

The APC circuit 403 set in the normal APC mode controls the light power of the laser beam output from a corresponding one of the LDs (LD1 to LDn) to the target light power in the above-described way, thereby executing APC for the corresponding LD.

(3) Initial APC Mode

To set the laser driving device 31 in the initial APC mode, the sequence controller 47 sets the charge mode signal OFF_APC*=“L” to turn on the S/H switch 503, thereby setting the hold capacitor 502 in the sample state. The sequence controller 47 also sets the OFF mode signal OFF_LD=“H” not to supply the driving current to the LD1 and turn off the LD1. The laser driving device 31 thus executes the initial charging operation.

(Initial Charging Operation)

In the laser driving device 31 during the initial charging operation, the LD1 does not emit light, and therefore, the light power monitor voltage Vpd=0. The light power monitor voltage Vpd=0 and the predetermined reference voltage Vref are input to the comparator 501. As a result, during the period when the charge mode signal OFF_APC*=“L”, the comparator 501 always continues determining that Vpd<Vref and supplying a current to the hold capacitor 502. Hence, the voltage Vsh of the hold capacitor 502 continues increasing at a predetermined charging speed.

When the charge mode signal OFF_APC*=“L”, the monitor switch 507 is turned on, and the comparator 506 monitors the voltage Vsh. The comparator 506 receives the voltage Vsh of the hold capacitor 502 and the target voltage Vst corresponding to the set value Vst_d of the sequence controller 47 from the voltage control circuit 505. More specifically, the comparator 506 compares the voltage Vsh with the target voltage Vst and determines whether

Vst≦Vsh (4)

Upon determining that inequality (4) is satisfied, the comparator 506 outputs the Ready signal representing it to the sequence controller 47 as the status signal S403.

Upon receiving the Ready signal from the APC circuit 403 (laser driving device 31), the sequence controller 47 determines that the voltage Vsh of the hold capacitor 502 corresponding to the LD1 has reached the target voltage Vst. In addition, the sequence controller 47 switches the charge mode signal OFF_APC* to “H” to end the initial charging operation for the LD1. The S/H switch 503 is thus turned off, and the hold capacitor 502 shifts to the hold state. The monitor switch 507 is also turned off, and monitoring of the voltage Vsh by the comparator 506 ends. In this manner, the initial charging operation in the laser driving device 31 ends.

(APC of Initial APC Mode)

After that, the sequence controller 47 switches the OFF mode signal OFF_LD to “L”, thereby causing the laser driving device 31 set in the initial APC mode to start supplying the driving current to the LD1. The LD1 thus switches from the turn-off state to the turn-on state. The sequence controller 47 also starts optical scanning for scanning the surface of the photosensitive member 11 by the laser beam output from the LD1, thereby starting BD signal detection. In addition, the sequence controller 47 switches the APC mode signal FULL from “L” to “H”, thereby turning on the S/H switch 503 again and executing APC for the LD1 in the turn-on state for a predetermined time.

By the APC of the initial APC mode, the APC circuit 403-1 controls the voltage Vsh such that the light power detected for the LD1 approaches the target light power, using, as the initial value, the voltage Vsh (≈Vst) of the hold capacitor 502 charged by the initial charging operation. The operation performed by the APC is the same as that performed in the above-described normal APC mode. As described above, at the start of the APC of the initial APC mode, the hold capacitor 502 is charged to the predetermined target voltage Vst near the reference voltage Vref corresponding to the target light power by the initial charging operation. Hence, in the APC performed in the turn-on state of the LD1, the light power of the LD1 can be controlled to the target light power in a short time as compared to a case in which the initial charging operation is not performed.

After that, the sequence controller 47 switches the APC mode signal FULL to “L” after the elapse of a predetermined time from the start of APC (time 614), thereby causing the laser driving device 31 to end the APC.

(4) VIDEO Mode

To set the laser driving device 31 in the VIDEO mode, the sequence controller 47 sets the charge mode signal OFF_APC*=“H” and the APC mode signal FULL=“L” to turn off the S/H switch 503. The hold capacitor 502 thus shifts to the hold state in which the voltage Vsh at that point of time is held. The switching current source 404-1 supplies the driving current Isw-1 corresponding to the held voltage Vsh to the LD1. The laser driving device 31 switches the driving current Isw-1 based on image data input from an image data generation unit (not shown) or the like, thereby modulating the driving current in accordance with the image data.

<Light Power Control in Laser Driving Device 31>

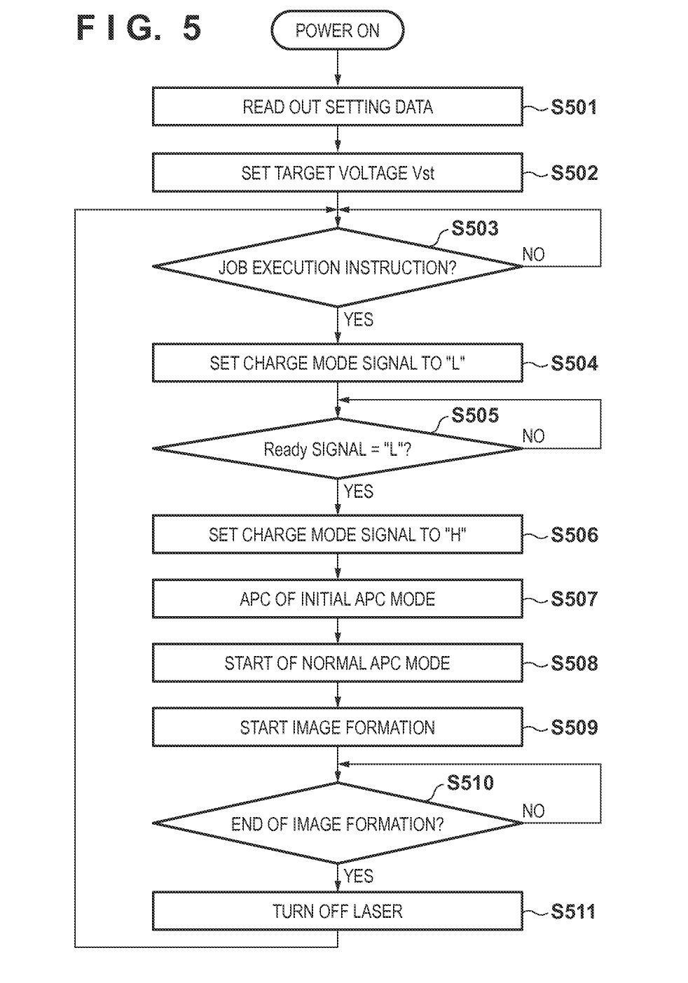

A series of operations in the normal APC mode and the initial APC mode which are executed by the image forming apparatus 100 according to this embodiment will be described next with reference to the flowchart of FIG. 5 and the light emission sequence chart of FIG. 6. Note that the processing of each step shown in FIG. 5 is implemented on the image forming apparatus 100 by causing the CPU (not shown) of the sequence controller 47 to read out a control program stored in a memory or the like in advance to a RAM (not shown) and execute the control program. The sequence controller 47 is assumed to start the processing shown in FIG. 5 upon powering on the image forming apparatus 100 and end the processing upon powering off.

In step S501, the CPU of the sequence controller 47 (to be simply referred to as the “CPU” hereinafter) reads out setting data representing the target voltage Vst and stored in a ROM (not shown) of the image forming apparatus 100 in advance. The setting data is stored in the ROM upon adjusting the image forming apparatus 100 at the time of shipment from the factory, and represents the voltage corresponding to the target light power of the LD1 to LDn. In step S502, the CPU supplies the readout setting data to the voltage control circuit 505 in the APC circuit 403, thereby setting the target voltage Vst used in the initial charging operation.

After that, in step S503, the CPU determines whether execution of a job including execution of image formation is instructed. As far as the CPU determines that the execution is not instructed, the processing in step S503 is repeated. Upon determining that the execution is instructed, the CPU advances the process to step S504. In step S504, the CPU sets the charge mode signal OFF_APC* to “L” (time 611). In this embodiment, the charge mode signal OFF_APC* is assumed to be common to the LD1 to LDn. The laser driving device 31 turns off the LD1 to LDn and executes the above-described initial charging operation for the LD1 to LDn before the start of optical scanning on the photosensitive member 11 by laser beams output from the LD1 to LDn. Note that the initial charging operation may be performed not for all of the LD1 to LDn but for only the LD1 as a representative laser.

During execution of the initial charging operation in the laser driving device 31, the CPU determines in step S505 whether the above-described Ready signal is received from one of the APC circuits 403-1 to 403-n. As far as the CPU determines that the Ready signal is not received, the determination processing is repeated. If the Ready signal is received from the APC circuit 403 corresponding to one of the LD1 to LDn (time 612), the CPU determines that the voltage Vsh of the hold capacitor 502 has reached the target voltage Vst in the APC circuit (in this case, the APC circuit 403-1 corresponding to the LD1) that has transmitted the Ready signal. As a result, the CPU advances the process to step S506 to set the charge mode signal=“H”, and ends the initial charging operation for all of the LD1 to LDn.

When the initial charging operation has ended, in step S507, the CPU executes the above-described APC of the initial APC mode for the representative laser (LD1) for a predetermined time (time 613 to time 614). More specifically, the CPU causes the laser driving device 31 to start supplying the driving current to the LD1 and drives the polygon motor to drive the polygon mirror 33, thereby starting optical scanning for the photosensitive member 11 by the laser beam output from the LD1.

At the same time as the start of BD signal detection, the light power of the LD1 is controlled to the target light power. When the BD signal detection period has stabilized, the CPU advances the process to step S508 to start the normal APC mode, as described above (time 614). In the normal APC mode, the CPU controls the laser driving device 31 such that the APC of the above-described normal APC mode is periodically executed for each LD in synchronism with the BD signal detection period. Next, in step S509, the CPU starts image formation based on the job accepted in step S503. Upon determining in step S510 that the image formation has ended, the CPU sets the OFF mode signal OFF_LD=“H” in step S511, thereby turning off the LD1 to LDn. The CPU then returns the process to step S503.

As described above, in this embodiment, when executing APC of the initial APC mode, the voltage Vsh of the hold capacitor 502 is raised to a voltage corresponding to the target light power or a light power near the target light power by the initial charging operation. It is therefore possible to control the LD to the target light power in a short time in the APC of the initial APC mode and the normal APC mode executed later, compared to a case in which the initial charging operation is not performed. In the above-described embodiment, although the plurality of LDs (LD1 to LDn) are used, the same advantage as described above can be obtained even when a single LD is used.

Note that the present invention can also be implemented even when the above-described embodiment is variously modified, as will be described below. In the above-described embodiment, the CPU ends the initial charging operation upon determining for any one of the LD1 to LDn that the voltage Vsh of the hold capacitor 502 has reached the target voltage Vst. However, for example, the image forming apparatus 100 (laser driving device 31) may end the initial charging operation and start optical scanning of the photosensitive member 11 upon determining that the raise of the corresponding voltage Vsh to the target voltage Vst is completed for at least one of the LD1 to LDn. Alternatively, the image forming apparatus may end the initial charging operation and start optical scanning of the photosensitive member 11 when the raise of the corresponding voltage Vsh to the target voltage Vst is completed for all of the LD1 to LDn. It is possible to control the light power of each LD to the target light power in a shorter time in the APC to be executed after the initial charging operation, by controlling the voltage to the target voltage Vst according to the initial charging operation for the plurality of (or all) LDs as described above.

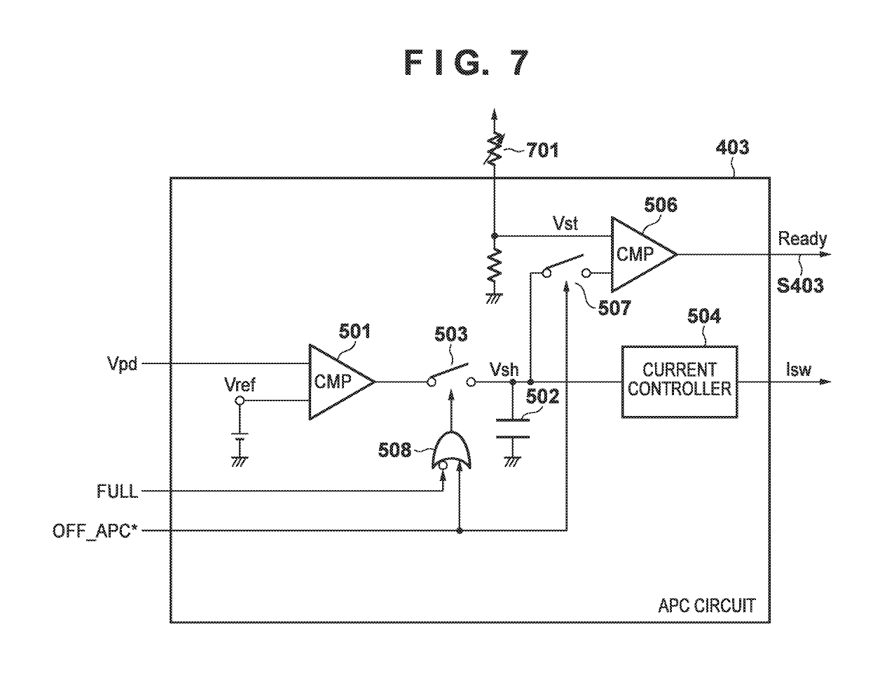

The APC circuit 403 of the above-described embodiment shown in FIG. 4 may have an arrangement shown in, for example, FIG. 7. In place of the voltage control circuit 505, a variable resistor 701 whose resistance value is adjusted in advance to set the target voltage Vst is connected outside the APC circuit 403 shown in FIG. 7. The resistance value of the variable resistor 701 is adjusted in advance by light power adjustment or the like at the time of shipment from the factory. In this case, a voltage generated in the variable resistor 701 in accordance with the resistance value is set to the target voltage Vst to be input to the comparator 506. The arrangement using the variable resistor 701 for the APC circuit 403 enables the initial charging operation to be implemented by a circuit arrangement simpler than in the above-described embodiment.

### Second Embodiment

In the first embodiment, a fixed value is used as the target voltage Vst in the APC circuit 403. In the second embodiment, a case in which a target voltage Vst is variable will be explained. Note that for the sake of descriptive simplicity, a description of parts common to the first embodiment will be omitted.

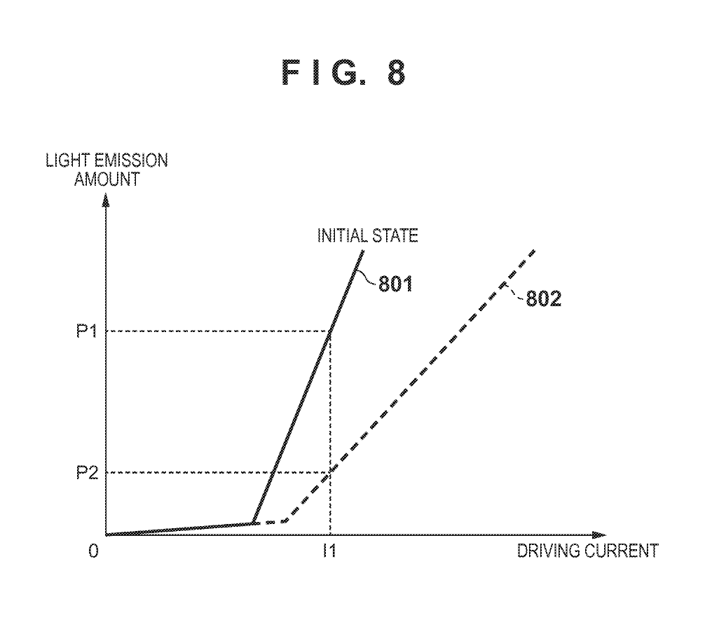

FIG. 8 shows a light emission characteristic 801 of an LD in the initial state at the time of shipment from a factory and a light emission characteristic 802 that has changed due to a temperature rise or aged deterioration. In general, the light emission efficiency of an LD with respect to the driving current (or a voltage Vsh of a hold capacitor 502) lowers due to a temperature rise or aged deterioration, as shown in FIG. 8. In FIG. 8, a light emission amount P1 in the initial state lowers to a light emission amount P2 after a temperature rise or aged deterioration with respect to a driving current I1 (P1>P2). As a result, the driving current (or the voltage Vsh of the hold capacitor) that makes the LD obtain a predetermined light emission amount changes. Hence, even when a decrease in the light emission efficiency has occurred in an LD due to a temperature rise or aged deterioration, the initial charging operation is desired to be accurately executed by appropriately setting the target voltage Vst in the initial charging operation set in correspondence with the decrease in the light emission efficiency.

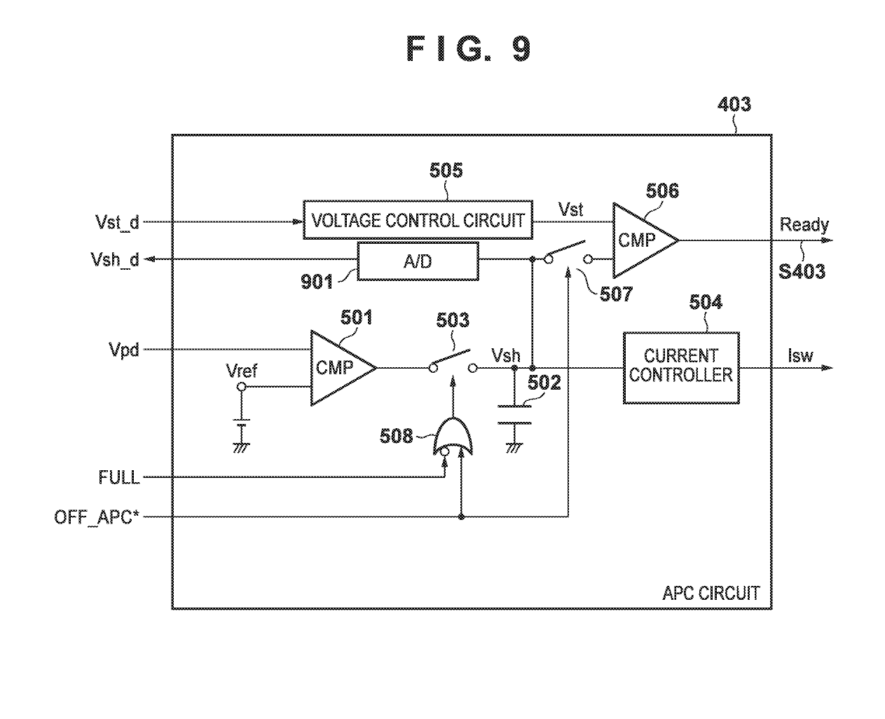

In this embodiment, an APC circuit 403 shown in FIG. 9 is used in place of the APC circuit 403 (FIG. 4) of the first embodiment, thereby making the target voltage Vst variable. The difference from the first embodiment (FIG. 4) is that an A/D circuit 901 configured to convert the voltage Vsh of the hold capacitor into a digital value Vsh_d and output it is provided. When the A/D circuit 901 outputs the digital value Vsh_d representing the voltage Vsh, a sequence controller 47 (CPU) can monitor the voltage Vsh.

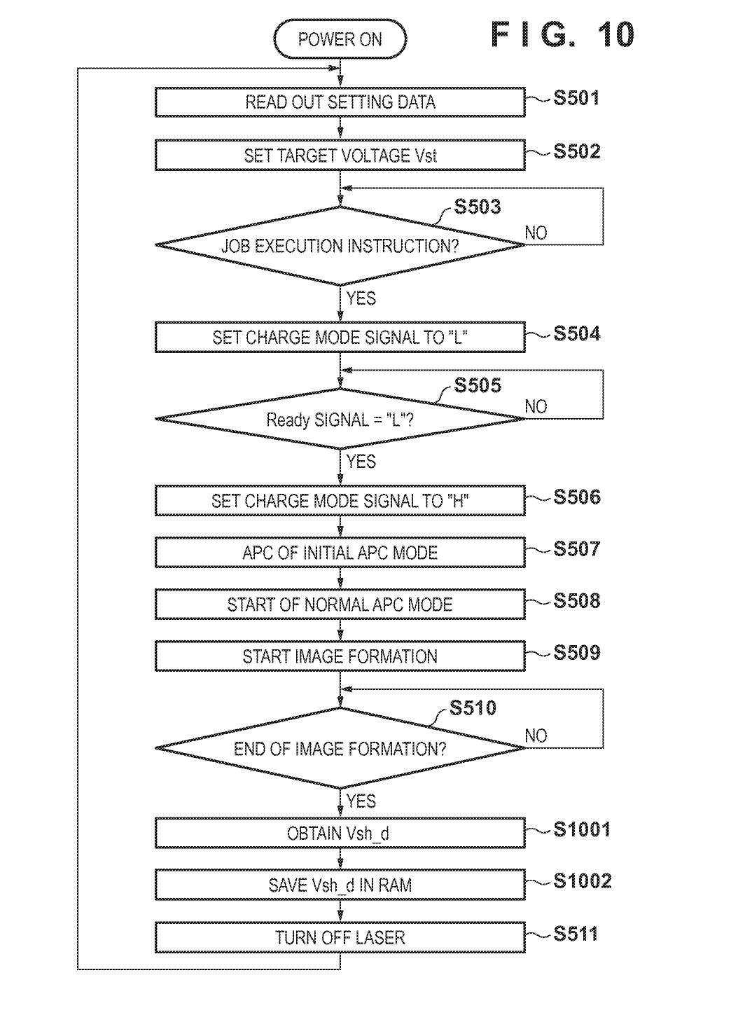

FIG. 10 is a flowchart showing a series of operations in the initial APC mode and the normal APC mode according to this embodiment. FIG. 10 is different from the first embodiment (FIG. 5) in that steps S1001 and S1002 are added, and the process returns from step S511 not to step S503 but to step S501.

In step S502, the CPU temporarily stores, in a RAM (not shown), setting data (a voltage representing the target voltage) read out from a ROM. In this embodiment, the RAM functions as a storage unit that stores, in advance, a voltage value representing a voltage corresponding to the target light power or a light power near the target light power.

Upon determining in step S510 that image formation has ended, the CPU advances the process not to step S511 but to step S1001. In step S1001, the CPU obtains, from the A/D circuit 901, the voltage value Vsh_d corresponding to the voltage Vsh held by the hold capacitor 502 of the APC circuit 403 for one of LD1 to LDn at the end of image formation, that is, at the end of optical scanning for a photosensitive member 11. In step S1002, the CPU saves the obtained voltage value Vsh_d in the RAM, thereby updating the setting data of the target voltage stored in the RAM.

At the start of next image formation (optical scanning) in an image forming apparatus 100, the CPU reads out the updated setting data (voltage value) stored in the RAM and supplies it to a voltage control circuit 505 corresponding to each LD in steps S501 and S502, thereby setting the target voltage Vst to be used in the initial charging operation.

In this embodiment, the voltage of the hold capacitor 502 after APC in the initial APC mode and the normal APC mode is used as the target voltage Vst in the next initial charging operation. This allows the target voltage Vst to be set in correspondence with the decrease in the light emission efficiency that can occur in each LD due to a temperature rise or aged deterioration. As a result, even when such a decrease in the light emission efficiency has occurred in each LD, the initial charging operation can accurately be executed for each LD.

### Third Embodiment

In the above-described embodiments, the present invention is applied to a so-called analog APC system that controls the light power by causing the hold capacitor 502 to sample/hold the voltage Vsh. In the third embodiment, a case in which the present invention is applied to a so-called digital APC system that provides an A/D circuit in an APC circuit 403 will be explained. Note that for the sake of descriptive simplicity, a description of parts common to the first embodiment will be omitted.

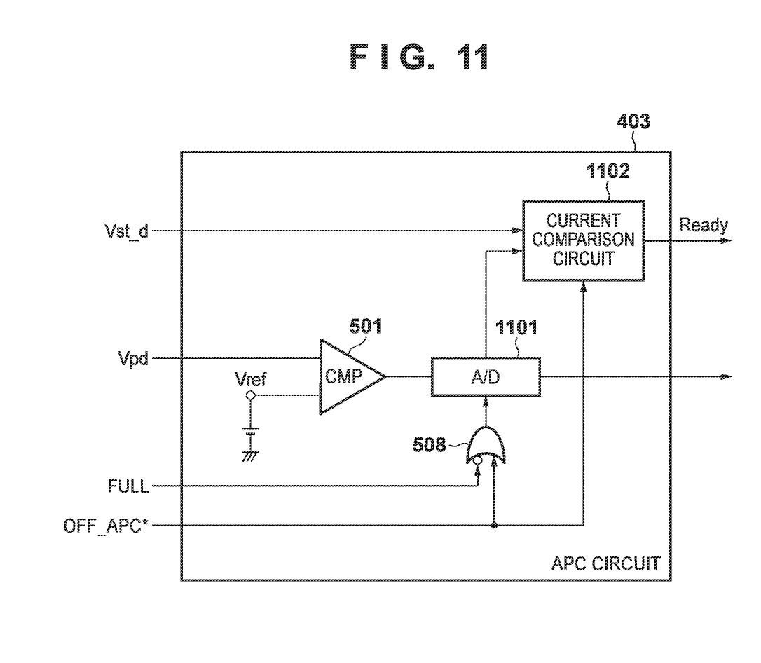

In this embodiment, the APC circuit 403 shown in FIG. 11 is used in place of the APC circuit 403 (FIG. 4) of the first embodiment. The main difference from the first embodiment (FIG. 4) is that a sequence controller 47 (CPU) inputs setting data Istd representing a target current value to the APC circuit 403 in place of setting data representing a target voltage Vst. The setting data input to the APC circuit 403 is supplied to a current comparison circuit 1102. The current comparison circuit 1102 is provided in the APC circuit 403 in place of the comparator 506. The APC circuit 403 also newly includes an A/D circuit 1101. In the APC circuit 403 shown in FIG. 11, the output voltage from a comparator 501 is supplied to the A/D circuit 1101. The A/D circuit 1101 holds a current value corresponding to the output voltage from the comparator 501 as the current value of the driving current used to cause the LD1 to LDn to output laser beams. That is, in this embodiment, the A/D circuit 1101 functions as a current holding unit.

In this embodiment, when the initial charging operation is executed in a laser driving device 31 in a state in which the LD1 to LDn are turned off, a current value Isw held by the A/D circuit 1101 is supplied to the current comparison circuit 1102. In the initial charging operation, the A/D circuit 1101 increases the held current value Isw based on a current supplied when the comparator 501 has determined that Vpd<Vref. Upon determining that the current value Isw is equal to or larger than the target current value Isw represented by the setting data Ist_d (Ist≦Isw), the current comparison circuit 1102 outputs a Ready signal representing it to the sequence controller 47 as a status signal S403. The laser driving device 31 thus ends the initial charging operation under the control of the CPU. The current value held by the A/D circuit 1101 is thus adjusted to the preset target current value by the initial charging operation.

After that, when APC of the initial APC mode starts, the APC circuit 403-1 controls the current value Isw such that the light power detected for the LD1 approaches the target light power using, as the initial value, the current value Isw (≈Ist) held by the A/D circuit 1101 and adjusted by the initial charging operation. Note that a series of operations in the initial APC mode and the normal APC mode executed in an image forming apparatus 100 according to this embodiment are the same as in the first embodiment (FIG. 5), and a description thereof will be omitted.

As described above, according to this embodiment, the present invention can be implemented not only in the analog APC system but also in the digital APC system based on a current value, and the same advantage as in the first embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-280242 filed Dec. 21, 2011 and 2012-269188 filed Dec. 10, 2012, which are hereby incorporated by reference herein in their entirety.

What is claimed is:

1. An optical scanning apparatus for scanning a photosensitive member by a light beam, comprising:
a light source configured to output the light beam having a light power according to a supplied driving current;
a detection unit configured to detect the light power of the light beam output from said light source;
a voltage holding unit configured to hold a voltage to be used to cause said light source to output the light beam;
a charging unit configured to charge said voltage holding unit to a predetermined voltage;
a control unit configured to control said charging unit so that the voltage holding unit is charged by the charging unit and configured to control the value of the driving current, wherein the control unit controls the charging unit so that the voltage holding unit holds a predetermined voltage in a state where the driving current is not supplied to said light source, controls the charging unit based on a detection result of the detection unit so that the voltage held in the voltage holding unit is controlled from the predetermined voltage of the voltage holding unit charged in the state where the driving current is not supplied to said light source, and controls the value of the driving current based on the voltage held in the voltage holding unit controlled by the control unit; and
a current supply unit configured to supply, to said light source, the driving current according to the voltage controlled by the control unit.

2. The apparatus according to claim 1, further comprising a comparison unit configured to compare a voltage corresponding to the light power detected by said detection unit with a reference voltage corresponding to a target light power,
wherein said control unit changes, in accordance with a comparison result of said comparison unit, the voltage held by said voltage holding unit from the predetermined voltage such that the voltage corresponding to the light power detected by said detection unit approaches the reference voltage.

3. The apparatus according to claim 2, further comprising a setting unit configured to set a voltage corresponding to one of a target light power and a light power near the target light power as the predetermined voltage.

4. The apparatus according to claim 3, further comprising:
a storage unit configured to store, in advance, a voltage value indicating a voltage corresponding to one of the target light power and the light power near the target light power; and
an updating unit configured to update the voltage value stored in said storage unit to a voltage value corresponding to the voltage held by said voltage holding unit,
wherein said setting unit sets a voltage corresponding to the voltage value updated by said updating unit and stored in said storage unit as the predetermined voltage at a start of next optical scanning.

5. The apparatus according to claim 1, further comprising a variable resistor whose resistance value is adjusted in advance to set the predetermined voltage,
wherein a voltage generated in said variable resistor in accordance with the resistance value is set as the predetermined voltage.

6. The apparatus according to claim 1, wherein
the optical scanning apparatus comprises a plurality of light sources, a plurality of voltage holding units, a plurality of charging units, a plurality of current supply units, and a plurality of control units, and the surface of the photosensitive member is scanned by a plurality of light beams output from said plurality of light sources, and
when at least one of said plurality of charging units has completed charging of a corresponding voltage holding unit to the predetermined voltage, the optical scanning apparatus changes said plurality of light sources from a turn-off state to a turn-on state to start optical scanning.

7. The apparatus according to claim 6, wherein when all of said plurality of charging units have completed charging of corresponding voltage holding units to the predetermined voltage, the optical scanning apparatus changes said plurality of light sources from the turn-off state to the turn-on state to start the optical scanning.

8. An optical scanning apparatus for scanning a photosensitive member by a light beam, comprising:
a light source configured to output the light beam having a light power according to a supplied driving current;
a detection unit configured to detect the light power of the light beam output from said light source;
a current holding unit configured to hold a current value of the driving current to be used to cause said light source to output the light beam;
an adjustment unit configured to adjust the current value held by said current holding unit to a predetermined current value;
a control unit configured to control the current value held by said current holding unit from the predetermined current value based on a detection result of said detection unit; and
a current supply unit configured to supply, to said light source, the driving current corresponding to the current value held by said current holding unit, which is controlled by said control unit.

9. An image forming apparatus comprising:
a photosensitive member;
a charger configured to charge said photosensitive member;
an optical scanning apparatus configured to scan the surface of said photosensitive member by a light beam output from a light source when a driving current modulated based on image information is supplied from a current supply unit to said light source; and
a developing unit configured to develop an electrostatic latent image formed on the surface of said photosensitive member by scanning of the light beam by said optical scanning apparatus to form, on the surface of said photosensitive member, an image to be transferred to a recording material,
wherein said optical scanning apparatus comprises:
said light source configured to output the light beam having a light power according to a supplied driving current;
a detection unit configured to detect the light power of the light beam output from said light source;
a voltage holding unit configured to hold a voltage to be used to cause said light source to output the light beam;
a charging unit configured to charge said voltage holding unit to a predetermined voltage;
a control unit configured to control said charging unit so that the voltage holding unit is charged by the charging unit and configured to control the value of the driving current, wherein the control unit controls the charging unit so that the voltage holding unit holds a predetermined voltage in a state where the driving current is not supplied to said light source, controls the charging unit based on a detection result of the detection unit so that the voltage held in the voltage holding unit is controlled from the predetermined voltage of the voltage holding unit charged in the state where the driving current is not supplied to said light source, and controls the value of the driving current based on the voltage held in the voltage holding unit controlled by the control unit; and
said current supply unit configured to supply, to said light source, the driving current according to the voltage held by said voltage holding unit.

10. An image forming apparatus comprising:
a photosensitive member;
a charger configured to charge said photosensitive member;
an optical scanning apparatus configured to scan the surface of said photosensitive member by a light beam output from a light source when a driving current modulated based on image information is supplied from a current supply unit to said light source; and
a developing unit configured to develop an electrostatic latent image formed on the surface of said photosensitive member by scanning of the light beam by said optical scanning apparatus to form, on the surface of said photosensitive member, an image to be transferred to a recording material,
wherein said optical scanning apparatus comprises:
said light source configured to output the light beam having a light power according to a supplied driving current;
a detection unit configured to detect the light power of the light beam output from said light source;
a current holding unit configured to hold a current value of the driving current to be used to cause said light source to output the light beam;
an adjustment unit configured to adjust the current value held by said current holding unit to a predetermined current value;
a control unit configured to control the current value held by said current holding unit from the predetermined current value based on a detection result of said detection unit; and
said current supply unit configured to supply, to said light source, the driving current corresponding to the current value held by said current holding unit, which is controlled by said control unit.
